(19) United States
(12) Patent Application Publication
(10) Pub. No.: US 2026/0094813 A1
(43) Pub. Date: Apr. 2, 2026

(54) CATHODE MATERIAL WITH DOUBLE-LAYER PARTICLE COATING

(71) Applicant: NISSAN NORTH AMERICA, INC., Franklin, TN (US)

(72) Inventors: Cenk GUMECI, Northville, MI (US); Santhanam RAMAN, Farmington Hills, MI (US); Sandeep PATIL, Farmington Hills, MI (US)

(21) Appl. No.: 18/902,829

(22) Filed: Sep. 30, 2024

(51) Int. Cl. H01M 4/36; H01M 4/02; H01M 4/38; H01M 4/505; H01M 4/525

(52) U.S. Cl. CPC H01M 4/366; H01M 4/38; H01M 4/505; H01M 4/525; H01M 2004/021; H01M 2004/028

(57) ABSTRACT

An electrode is provided. The electrode includes an electrode material comprising a plurality of electrode active material particles. Each of the plurality of electrode active material particles includes a core, a first coating layer formed on a first surface of the core, and a second coating layer formed on a second surface of the first coating layer. The core is formed of a lithium transition metal oxide material. The first coating layer includes a platinum alloy. The second coating layer includes a metal oxide. The present invention also relates to a battery including the electrode material.

### BACKGROUND

### Field of the Invention

The present invention generally relates to an electrode material for a battery, in particular a cathode material. The electrode material includes a plurality of electrode active material particles. Each of the plurality of electrode active material particles includes a core, a first coating layer formed on a first surface of the core, and a second coating layer formed on a second surface of the first coating layer. The core is formed of a lithium transition metal oxide material. The first coating layer includes a platinum alloy. The second coating layer includes a metal oxide. The present invention also relates to a battery including the electrode material.

### Background Information

Lithium-based batteries that include lithium metal anodes or lithium-based cathode material are desirable because they have a high energy density and, thus, can generate a large amount of power with a relatively thin electrode structure, thus permitting a reduction in the size of the battery as compared with other conventional batteries including anodes made of carbon or silicon.

Lithium-ion batteries that include lithium metal anodes or lithium-based cathode materials are desirable because they have a high energy density and, thus, can generate a large amount of power with a relatively thin electrode structure, thus permitting a reduction in the size of the battery as compared with other conventional batteries including anodes made of carbon or silicon. Lithium-ion batteries use lithium metal anodes and cathodes formed of complex oxides such as lithium nickel manganese cobalt oxide (LiNiMnCoO₂, also commonly referred to as “NMC”).

NMC materials are desirable because of their low cost and high energy density. NMC materials are also environmentally friendly, have a long cycle life and have a high structural stability. NMC materials can also be used in a wide variety of applications. For example, nickel-rich cathode materials such as NMC are a key component in batteries used for electric vehicles. These nickel-rich NMC materials have a high percentage of nickel (e.g., NCM-811 containing 80% nickel) and can store more energy than other lithium oxide cathode materials.

However, there are several drawbacks with lithium-ion batteries using conventional NMC materials. For example, the high nickel content of conventional NMC materials can lead to the formation of microcracks during charge-discharge cycles. These cracks can then propagate and cause the cathode material to degrade faster. Nickel and other transition metals in the cathode material can dissolve into the electrolyte, leading to capacity loss and reduced battery life.

In order to protect the NMC particles and thereby suppress the surface decomposition of the cathode material and stabilize the SEI interface between the electrode and the electrolyte, cathode materials have been developed that use one or more layers of an oxide coating. However, the oxide coating(s) alone are insufficient to protect the NMC or other nickel-rich cathode active material particles from decomposition and prevent dissolution of the transition metals of the oxide into the electrolyte.

Therefore, further improvement is needed to sufficiently protect the nickel-rich transition metal oxide materials and improve the overall performance of the lithium-ion battery. In particular, it is desirable to reduce the formation of cracks in the cathode active material particles during charge-discharge and prevent dissolution of the transition metals in the active material particles to thereby improve the overall performance of the battery.

### SUMMARY

It has been discovered that the durability and overall battery performance can be further improved by providing a double-layer coating on the surface of the nickel-rich cathode active material particles. In particular, it has been discovered that the formation of cracks in the cathode material and the dissolution of the transition metals into the electrolyte can be prevented by providing a first platinum alloy coating directly on the lithium transition metal oxide material and a second oxide coating over the first coating.

In view of the state of the known technology, one aspect of the present disclosure is to provide an electrode for a battery. The electrode includes an electrode material comprising a plurality of electrode active material particles. Each of the plurality of electrode active material particles includes a core, a first coating layer formed on a first surface of the core, and a second coating layer formed on a second surface of the first coating layer. The core is formed of a lithium transition metal oxide material. The first coating layer includes a platinum alloy. The second coating layer includes a metal oxide. The present invention also relates to a battery including the electrode material.

By providing the outer oxide coating layer, the nickel-rich cathode active material particles can be protected from surface phase reconstruction, oxygen release, inter-and intra-granular cracking and degradation from the liquid electrolyte, in particular when the cathode active material particles are single crystal NMC particles. Furthermore, by providing the inner platinum alloy coating layer, the reduction of the metal ions in the nickel-rich cathode active material particles can be mitigated. In particular, when the platinum alloy is doped with an inert element such as nitrogen, the nitrogen creates a bond with the cation of the nickel-rich oxide, thereby mitigating the reduction of the metal cation and the resulting degradation in battery characteristics.

Another aspect of the present disclosure is to provide a battery. The battery includes an anode comprising an anode material, a cathode comprising a cathode material, and a separator disposed between the anode and the cathode. The cathode material includes a plurality of cathode active material particles. Each of the plurality of cathode active material particles includes a core, a first coating layer formed on a first surface of the core, and a second coating layer formed on a second surface of the first coating layer. The core is formed of a lithium transition metal oxide material. The first coating layer includes a platinum alloy. The second coating layer includes a metal oxide.

By providing the oxide coating layer, the cathode active material particles can be protected from surface phase reconstruction, oxygen release, inter-and intra-granular cracking and degradation from the liquid electrolyte. Furthermore, by providing the platinum alloy coating layer, the reduction of the metal ions in the nickel-rich cathode active material particles can be mitigated. In particular, when the platinum alloy is doped with an inert element such as nitrogen, the nitrogen creates a bond with the cation of the nickel-rich oxide, thereby mitigating the reduction of the metal cation and the resulting degradation in battery characteristics.

### BRIEF DESCRIPTION OF THE DRAWINGS

Referring now to the attached drawings which form a part of this original disclosure:

FIG. 1a is a cross-sectional view of a battery according to a first embodiment;

FIG. 1b is an enlarged cross-sectional view of a cathode active material particle of the battery according to the first embodiment; and

FIG. 2 is a cross-sectional view of a battery according to a second embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

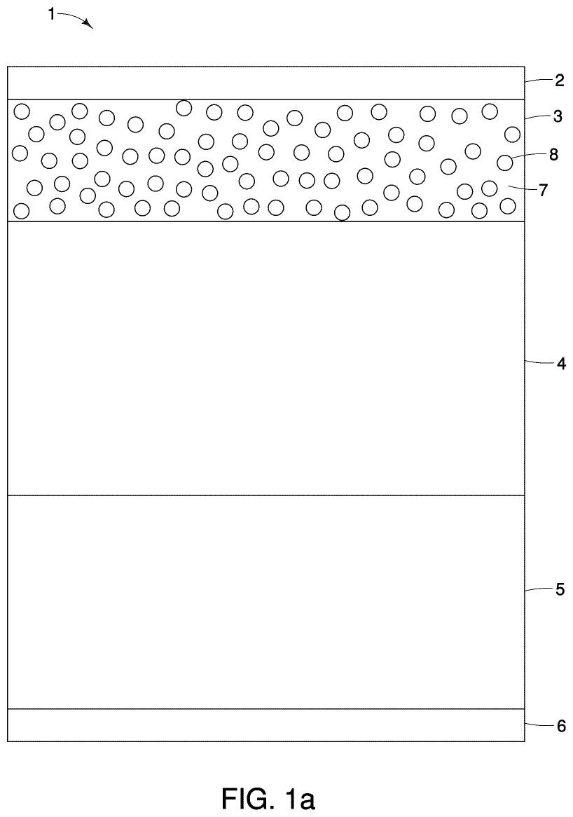

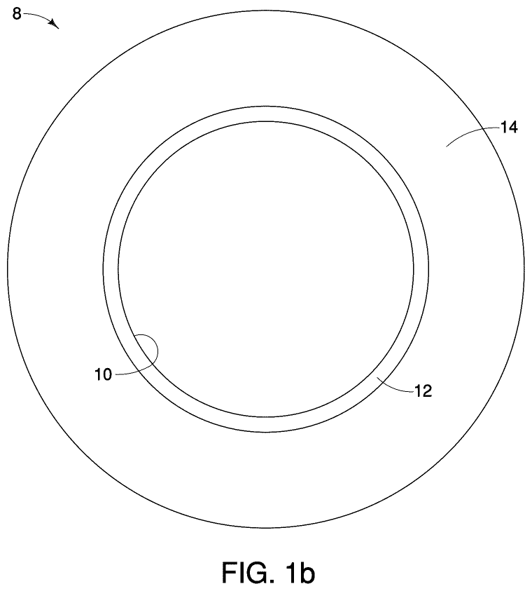

Referring initially to FIG. 1a, a battery 1 is illustrated in accordance with a first embodiment. The battery 1 is a lithium-ion battery having a nonaqueous liquid electrolyte contained therein. The battery 1 can be used in a vehicle, an energy storage system, a laptop computer, a mobile device or other suitable personal electronic device.

As shown in FIG. 1a, the battery 1 includes a cathode current collector 2, a cathode 3, a separator 4, an anode 5, and an anode current collector 6. The cathode current collector 2 is formed of any suitable metal material, such as aluminum or copper, preferably aluminum. The cathode current collector 2 has a thickness ranging from 5 μm to 25 μm, preferably 10 μm to 12 μm.

The cathode 3 includes a cathode material 7 disposed on the cathode current collector 2. The cathode material 7 has a total thickness of 70 μm to 160 μm. The cathode material 7 includes a plurality of cathode active material particles 8.

As shown in FIG. 1b, the cathode active material particles 8 each have a core 10, a first coating layer 12, and a second coating layer 14. The core 10 includes a lithium transition metal oxide material. The lithium transition metal oxide material can be any suitable transition metal oxide material for a lithium-ion battery. For example, the lithium transition metal oxide material can be NMC, lithium nickel cobalt aluminum oxide having the formula LiNiₓCo_{y}Al_{z}O₂, where x+y+z=1 (“NCA”), lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), lithium phosphate, or LiFePO₄ (“LFP”). The lithium transition metal oxide material is preferably NMC.

The lithium transition metal oxide material can also be a single crystal or polycrystalline material. The lithium transition metal oxide material is preferably single crystal NMC. The core 10 has a size or diameter of approximately 2 μm to 20 μm. The core 10 is formed by following methods: a solid state synthesis, co-precipitation synthesis, or a sol-gel synthesis.

The first coating layer 12 is a thin layer formed on an outer surface of the core 10. The first coating layer 12 has a thickness of approximately 0.1 nm to 0.5 nm. The first coating layer 12 includes a platinum alloy. The first coating layer 12 also preferably includes an inert element, such as nitrogen or sulfur, doped in the platinum alloy. The amount of nitrogen and/or sulfur is very small, and the nitrogen and sulfur are atomically inserted into the lattice of the platinum alloy (e.g., PtNi). By including the nitrogen and/or sulfur, the durability of the layer can be improved.

The platinum alloy includes platinum but can optionally include a complementary metal such as palladium. For example, the platinum alloy can be Pt₃M(111)-N, where M is a metal. Examples of the platinum alloy include Pt₃Ni—N, Pt₃Y—N, Pt₃Pd—N, Pt₃Co—N, Pt₃—Ni, Pt—Pd, Pt—Au, Pt—Ag, and mixtures thereof. The platinum alloy is preferably Pt₃Ni—N. The platinum alloy can have various amounts of Pt. If the alloy is Pt—Ni, the composition of Pt:Ni can be 75:25, 50:50 or 25:75. The first coating layer 12 can be coated on the core 10 in any suitable manner. For example, the first coating layer 12 can be deposited on the core 10 by casting, electrospraying, electrodeposition or atomic layer deposition.

The second coating layer 14 is formed on an outer surface of the first coating layer 12 and is significantly thicker than the first coating layer 12. For example, the second coating layer 14 has a thickness of 1 nm to 10 nm. The second coating layer 14 includes at least one metal oxide. The at least one metal oxide includes any suitable metal oxide(s), such as aluminum oxide (Al₂O₃), zirconium oxide (ZrO₂), magnesium oxide (MgO), and zinc oxide (ZnO). The at least one metal oxide is preferably aluminum oxide, zirconium oxide or a mixture thereof. The second coating layer 14 can be coated on the first coating layer 12 in any suitable manner. For example, the second coating layer 14 can be deposited on the first coating layer 12 by casting, electrospraying, electrodeposition or atomic layer deposition.

The cathode material 7 can also optionally include a binder and/or an additive. The cathode material 7 includes approximately 0% to 2% by weight of the binder relative to a total weight of the cathode material 7. The binder can be any suitable electrode binder material. For example, the binder can include polyvinylidene fluoride (“PVDF”), polytetrafluoroethylene (“PTFE”), polyvinyl alcohol, polyacrylic acid or a mixture thereof. The cathode material 7 includes approximately 0% to 2% by weight of the additive. The additive can be any suitable sacrificial electrode additive, such as carbon nanotubes, nanosized carbon, or a mixtures thereof.

The separator 4 is formed of any suitable material configured to hold a liquid electrolyte. For example, the separator 4 is formed of a polymer, preferably polyethylene and/or polypropylene. The separator 4 has a thickness of approximately 5 μm to 30 μm.

The separator 4 also includes a nonaqueous liquid electrolyte (not shown). Any suitable nonaqueous liquid electrolyte may be used. For example, the electrolyte includes at least one lithium salt, such as lithium hexafluorophosphate (LiPF₆) and/or lithium bis(trifluoromethanesulfonyl)imide (“Li-TFSI”), and at least one solvent. The at least one solvent includes ethylene carbonate (“EC”), diethylene carbonate (“DEC”), dimethyl carbonate (“DMC”), ethylmethyl carbonate (“EMC”), or mixtures thereof. The electrolyte can optionally include at least one additive such as vinylene carbonate (“VC”), fluoroethylene carbonate (“FEC), and propane sultone (“PS”).

The anode 5 includes an anode material disposed on the anode current collector 6. The anode material includes an anode active material. The anode active material can be any suitable anode active material for a lithium-ion battery, such as lithium metal, graphite, hard carbon, silicon, a silicon-graphite composite, lithium titanium oxide (“LTO”), graphene, a composite of silicon and graphene oxide, or a lithium metal alloy.

The anode material can also optionally include a binder and/or an additive. The anode material includes approximately 1% to 2% by weight of the binder relative to a total weight of the cathode material. The binder can be any suitable electrode binder material. For example, the binder can include PVDF, SBR, CMC, PTFE, Nafion, or a mixture thereof. The anode material includes approximately 1% to 4% by weight of the additive. The additive can be any suitable sacrificial electrode additive, such as carbon, carbon nanotubes, carbon nanofibers, graphene, a graphene oxide-graphene composite, graphene nanotubes, or a mixture thereof. The anode 6 has a total thickness of approximately 50 μm to 130 μm.

The anode current collector 6 is formed of any suitable metal, such as aluminum or copper, preferably copper. The anode current collector 6 has a thickness ranging from 5 μm to 25 μm, preferably 10 μm to 12 μm.

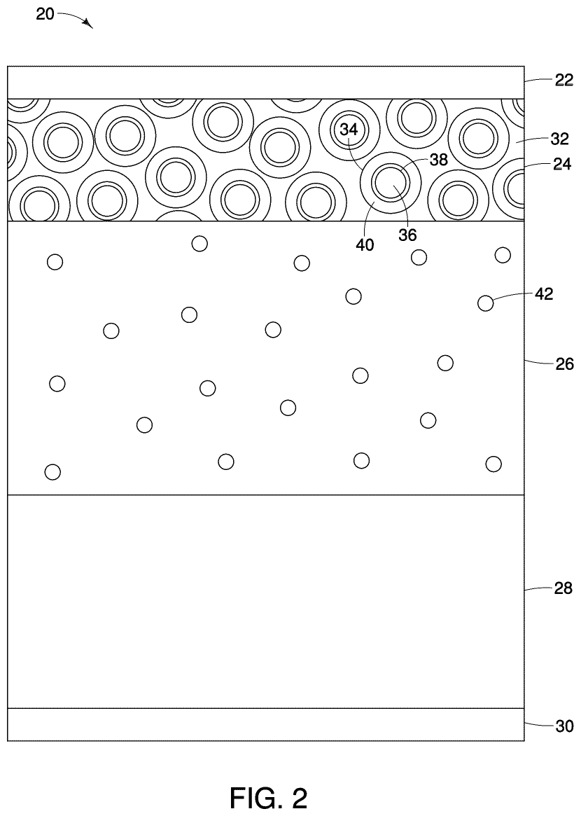

FIG. 2 shows a cross-sectional view of a battery 20 according to a second embodiment. The battery 20 is a solid-state battery. The battery 20 can be used in a vehicle, an energy storage system, a laptop computer, a mobile device or other suitable personal electronic device. The solid-state battery 20 is preferably an all-solid-state battery.

As shown in FIG. 2, the battery 20 includes a cathode current collector 22, a cathode 24, an electrolyte 26, an anode 28, and an anode current collector 30. The cathode current collector 22 is formed of any suitable metal material, such as aluminum or copper, preferably aluminum. The cathode current collector 22 has a thickness ranging from 5 μm to 25 μm, preferably 10 μm to 12 μm.

The cathode 24 includes a cathode material 32 disposed on the cathode current collector 24. The cathode material 32 has a total thickness of 70 μm to 160 μm. The cathode material 32 includes a plurality of cathode active material particles 34.

As shown in FIG. 2, the cathode active material particles 34 each have a core 36, a first coating layer 38, and a second coating layer 40. The core 36 includes a lithium transition metal oxide material. The lithium transition metal oxide material can be any suitable transition metal oxide material for a lithium-ion battery. For example, the lithium transition metal oxide material can be NMC, NCA, lithium cobalt oxide (LiCoO₂), lithium nickel oxide (LiNiO₂), lithium manganese oxide (LiMn₂O₄), lithium nickel manganese oxide (LiNi_{0.5}Mn_{1.5}O₄), lithium phosphate, or LFP. The lithium transition metal oxide material is preferably NMC.

The lithium transition metal oxide material can also be a single crystal or polycrystalline material. The lithium transition metal oxide material is preferably single crystal NMC. The core 36 has a size or diameter of approximately 2 μm to 20 μm. The core 10 is formed by following methods: a solid state synthesis, co-precipitation synthesis, or a sol-gel synthesis.

The first coating layer 38 is a thin layer formed on an outer surface of the core 36. The first coating layer 38 has a thickness of approximately 0.1 nm to 0.5 nm. The first coating layer 38 includes a platinum alloy. The first coating layer 38 also preferably includes an inert element, such as nitrogen or sulfur, doped in the platinum alloy. The amount of nitrogen and/or sulfur is very small, and the nitrogen and sulfur are atomically inserted into the lattice of the platinum alloy (e.g., PtNi). By including the nitrogen and/or sulfur, the durability of the layer can be improved.

The platinum alloy includes platinum but can optionally include a complementary metal such as palladium. For example, the platinum alloy can be Pt₃M(111)-N, where M is a metal. Examples of the platinum alloy include Pt₃Ni—N, Pt₃Y—N, Pt₃Pd—N, Pt₃Co—N, Pt₃—Ni, Pt—Pd, Pt—Au, Pt—Ag, and mixtures thereof. The platinum alloy is preferably Pt₃Ni—N. The platinum alloy can have various amounts of Pt. If the alloy is Pt—Ni, the composition of Pt:Ni can be 75:25, 50:50 or 25:75. The first coating layer 38 can be coated on the core 36 in any suitable manner. For example, the first coating layer 38 can be deposited on the core 36 by casting, electrospraying, electrodeposition or atomic layer deposition

The second coating layer 40 is formed on an outer surface of the first coating layer 38 and is significantly thicker than the first coating layer 38. For example, the second coating layer 40 has a thickness of 1 nm to 10 nm. The second coating layer 40 includes at least one metal oxide. The at least one metal oxide includes any suitable metal oxide(s), such as aluminum oxide (Al₂O₃), zirconium oxide (ZrO₂), magnesium oxide (MgO), and zinc oxide (ZnO). The at least one metal oxide is preferably aluminum oxide, zirconium oxide or a mixture thereof. The second coating layer 40 can be coated on the first coating layer 38 in any suitable manner. For example, the second coating layer 40 can be deposited on the first coating layer 38 by casting, electrospraying, electrodeposition or atomic layer deposition.

The cathode material 32 can also optionally include a binder and/or an additive. The cathode material 32 includes approximately 0% to 2% by weight of the binder relative to a total weight of the cathode material 32. The binder can be any suitable electrode binder material. For example, the binder can include PVDF, PTFE, polyvinyl alcohol, polyacrylic acid or a mixture thereof. The cathode material 32 includes approximately 0% to 2% by weight of the additive. The additive can be any suitable sacrificial electrode additive, such as carbon nanotubes, nanosized carbon, or a mixtures thereof.

The electrolyte 26 is formed of solid electrolyte particles 42. The solid electrolyte particles 42 are formed of any suitable lithium-ion conductive solid electrolyte or solid polymer electrolyte for a solid-state battery. For example, the lithium-ion conductive solid electrolyte can be a sulfide-based solid electrolyte, such as Li₆PS₅Cl, an oxide solid electrolyte, a solid polymer electrolyte, or a hybrid solid electrolyte that includes a sulfide-based solid electrolyte and polyethylene oxide-based polymer. The electrolyte 26 has a thickness of approximately 20 μm to 600 μm.

The anode 28 includes an anode material disposed on the anode current collector 30. The anode material includes an anode active material. The anode active material can be any suitable anode active material for a lithium-ion battery, such as lithium metal, graphite, hard carbon, silicon, a silicon-graphite composite, LTO, graphene, a composite of silicon and graphene oxide, or a lithium metal alloy.

The anode material can also optionally include a binder and/or an additive. The anode material includes approximately 1% to 2% by weight of the binder relative to a total weight of the cathode material. The binder can be any suitable electrode binder material. For example, the binder can include PVDF, SBR, CMC, PTFE, Nafion, or a mixture thereof. The anode material includes approximately 1% to 4% by weight of the additive. The additive can be any suitable sacrificial electrode additive, such as carbon, carbon nanotubes, carbon nanofibers, graphene, a graphene oxide-graphene composite, graphene nanotubes, or a mixture thereof. The anode 28 has a total thickness of approximately 50 μm to 130 μm.

The anode current collector 30 is formed of any suitable metal, such as aluminum or copper, preferably copper. The anode current collector 30 has a thickness ranging from 5 μm to 25 μm, preferably 10 μm to 12 μm.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “substantially”, “about” and “approximately” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. An electrode comprising:
an electrode material comprising a plurality of electrode active material particles,
each of the plurality of electrode active material particles comprising:
a core formed of a lithium transition metal oxide material;
a first coating layer formed on a first surface of the core, the first coating layer comprising a platinum alloy; and
a second coating layer formed on a second surface of the first coating layer, the second coating layer comprising a metal oxide.

2. The electrode according to claim 1, wherein
the lithium transition metal oxide material comprises nickel.

3. The electrode according to claim 1, wherein
the lithium transition metal oxide material includes a lithium nickel manganese cobalt oxide.

4. The electrode according to claim 3, wherein
the lithium transition metal oxide material has a single crystal structure.

5. The electrode according to claim 1, wherein
the core has a size of approximately 2 μm to 20 μm.

6. The electrode according to claim 1, wherein
the platinum alloy comprises at least one of nitrogen and sulfur.

7. The electrode according to claim 1, wherein
the first coating layer has a thickness of approximately 0.1 nm to 0.5 nm.

8. The electrode according to claim 1, wherein
the metal oxide of the second coating layer comprises at least one of aluminum, zirconium, zinc and magnesium.

9. The electrode according to claim 1, wherein
the second coating layer has a thickness of approximately 1 nm to 10 nm.

10. A battery comprising:
an anode comprising an anode material:
a cathode comprising a cathode material; and
a separator disposed between the anode and the cathode,
the cathode material comprising a plurality of cathode active material particles, and each of the plurality of cathode active material particles comprising:
a core formed of a lithium transition metal oxide material;
a first coating layer formed on a first surface of the core, the first coating layer comprising a platinum alloy; and
a second coating layer formed on a second surface of the first coating layer, the second coating layer comprising a metal oxide.

11. The battery according to claim 10, wherein
the lithium transition metal oxide material comprises nickel.

12. The battery according to claim 10, wherein
the lithium transition metal oxide material includes a lithium nickel manganese cobalt oxide.

13. The battery according to claim 10, wherein
the core has a size of approximately 2 μm to 20 μm.

14. The battery according to claim 10, wherein
the platinum alloy comprises at least one of nitrogen and sulfur.

15. The battery according to claim 10, wherein
the first coating layer has a thickness of approximately 0.1 nm to 0.5 nm.

16. The battery according to claim 10, wherein
the metal oxide of the second coating layer comprises at least one of aluminum, zirconium, zinc and magnesium.

17. The battery according to claim 10, wherein
the second coating layer has a thickness of approximately 1 nm to 10 nm.

18. The battery according to claim 10, wherein
the anode comprises an anode active material selected from the group consisting of: graphite, silicon, a silicon-graphite composite, lithium metal, lithium titanium oxide, graphene, a composite of silicon and graphene oxide, and a lithium metal alloy.

19. The battery according to claim 10, further comprising
a liquid electrolyte provided in the separator.

20. The battery according to claim 10, wherein
the separator is formed of at least one selected from the group consisting of: polyethylene and polypropylene.
